(19) United States
(12) Patent Application Publication
(10) Pub. No.: US 2014/0204763 A1
(43) Pub. Date: Jul. 24, 2014

(54) Method and System for Routing Data

(71) Applicant: Aruba Networks, Inc., Sunnyvale, CA (US)

(72) Inventors: Sandip Kumar Devnath, Bangalore (IN); Rajneesh Bajpai, San Jose, CA (US); Praneet Bachheti, Fremont, CA (US)

(73) Assignee: Aruba Networks, Inc., SunnyVale, CA (US)

(21) Appl. No.: 13/749,540

(22) Filed: Jan. 24, 2013

(51) Int. Cl. H04L 12/56

(52) U.S. Cl. CPC H04L 45/124
USPC 370/238

(57) ABSTRACT

A method includes identifying internal links or forwarding elements within other network devices. The method further includes selecting a route for forwarding a packet through the other network devices based, at least in part, on link costs associated with the internal links within the other network devices.

### TECHNICAL FIELD

The present disclosure relates to routing data between network devices. In particular, the present disclosure relates to routing data based on links associated with line cards within network devices.

### BACKGROUND

Internet traffic has grown drastically every year for the last several years. To handle this traffic, high performance Internet Protocol (IP) networks have been modified to forward large amounts of data traffic at high speeds. Advancements include modifications to network devices such as routers, switches, and/or hubs which form the backbone of the IP networks by receiving data via ports and forwarding data via ports.

Routers, switches, and hubs have been modified to include multiple line cards, each with respective sets of ports for receiving or transmitting data. A line card (also known as a digital line card or forwarding chip) is a modular electronic circuit on a printed circuit board that interfaces with a telecommunications access network via ports. Data packets received on one line card of a router may be transmitted to a different line card within the same router for forwarding toward a destination address for the data packets.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 shows a block diagram example of a system in accordance with one or more embodiments;

FIG. 2 shows a block diagram example of a network device in accordance with one or more embodiments;

FIG. 3 illustrates an example method in accordance with one or more embodiments.

### DETAILED DESCRIPTION

In the following description, for the purposes of explanation, numerous specific details are set forth in order to provide a thorough understanding. One or more embodiments may be practiced without these specific details. Features described in one embodiment may be combined with features described in a different embodiment. In some examples, well-known structures and devices are described with reference to a block diagram form in order to avoid unnecessarily obscuring the present invention.

### General Overview

In an embodiment, an internal topology of a network device is exposed to and used by other network devices to determine packet routes. An internal link between different line cards within a first network device is exposed at least to a second network device. The second network device selects a route to a packet destination address based at least in part on the internal link between the different line cards. In one example, the second network device stores route information for (a) a first route from the second network device to a third network device via the first network device, the route information indicating that the first route includes traversal of the internal link within the first network device from a first line card to a second line card and (b) a second route from the second network device to the third network device via a fourth network device where the second route does not include traversal of any internal links within the fourth network device (i.e., a line card receiving the data at the fourth network device is the same line card that forwards the data to the third network device).

In an embodiment, each line card within a network device is individually addressable by other network devices. In an example, a first network device determines that a packet should be sent to a particular line card of a set of line cards within a network device, the particular line card being selected as a target intermediate destination to reach a final packet destination. The first network device accesses a routing table identifying a route to the particular line card and uses the route for forwarding a packet to the particular line card.

### Architectural Overview

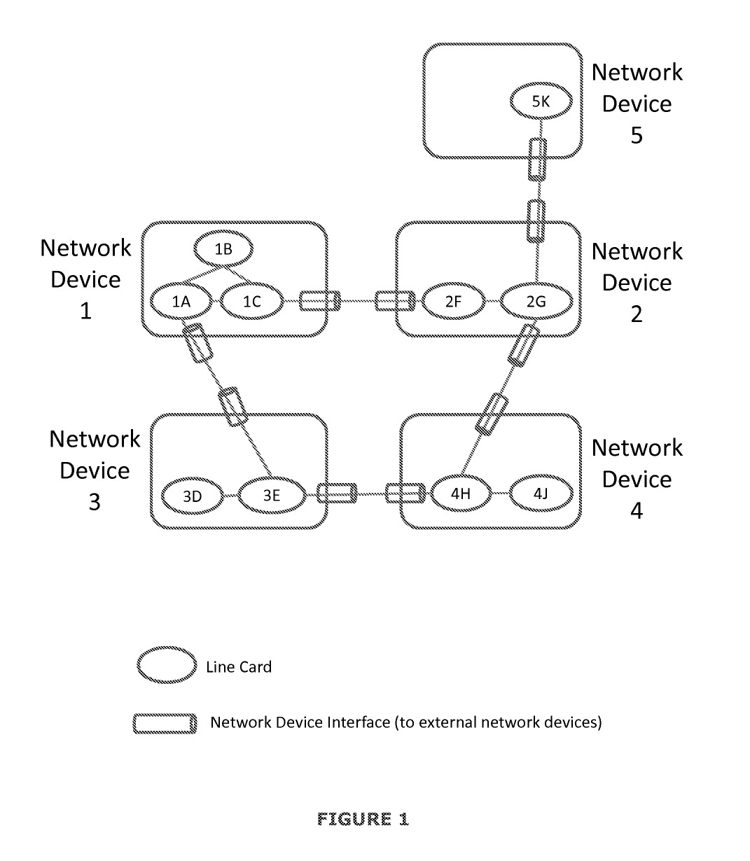

FIG. 1 shows a block diagram example of a system which includes digital devices in accordance with one or more embodiments. In one or more embodiments, System 1 may include more or less digital devices, than the devices illustrated in FIG. 1.

The term “digital device” generally refers to any hardware device that includes a processor. When the digital device is adapted for communications with a network, the digital device may be configured as a network device, a client device, or both. A digital device may refer to a physical controller device or a hardware device executing a virtual controller. Examples of digital devices include a computer, a tablet, a laptop, a desktop, a netbook, a server, a web server, authentication server, an authentication-authorization-accounting (AAA) server, a Domain Name System (DNS) server, a Dynamic Host Configuration Protocol (DHCP) server, an Internet Protocol (IP) server, a Virtual Private Network (VPN) server, a network policy server, a mainframe, a television, a content receiver, a set-top box, a video gaming console, a printer, a mobile handset, a smartphone, a personal digital assistant “PDA”, a wireless receiver and/or transmitter, an access point, a base station, a communication management device, a router, a switch, and/or a controller.

System 1, as illustrated in FIG. 1, is a system example that includes network devices 1-5. In an embodiment, a “network device” is a digital device that is configured to provide a network service. Examples of network devices include but are not limited to hubs, switches, and routers. Each network device may include a number of ports that provide the connection points to other network devices or client devices. In one example, a network device is a switch configured to receive packets and forward packets toward a destination node (either to an intermediate node or to the destination node itself).

In an embodiment, network device 3 includes two forwarding elements. A forwarding element is any device component which includes functionality to receive a packet from an internal or external source, determine an internal or external destination for the packet, and forward the packet to the internal or external destination. A forwarding element within network device 3 may receive data from other network devices (for example, network device 1 or network device 4) via a corresponding set of ports associated with the forwarding element.

In an embodiment, information for forwarding elements within a network device is transmitted to other network devices. In an example, one or more of: a number of forwarding elements, an identification or label of each forwarding element, a list of ports within each forwarding element, and a list of connections associated with forwarding element may be transmitted to other network devices. Other network devices may use the information for forwarding elements when determining routes for forwarding packets.

One example type of a forwarding element is a line card. In an embodiment, a line card (also referred to as a digital line card) is a modular electronic circuit on a printed circuit board that interfaces with a network via network device interfaces. Each set of network device interfaces, also referred to herein as ports, correspond to a respective line card. As illustrated in FIG. 1, network device 1 includes line card 1A, line card 1B, and line card 1C; network device 2 includes line card 2F and line card 2G, network device 3 includes line cards 3D and 3E; network device 4 includes line cards 4H and 4J; and network device 5 includes line card 5K. Different types and/or numbers of line cards may be used in accordance with one or more embodiments. For purposes of clarity and explanation, line cards are illustrated and explained in examples, although embodiments are equally applicable to any other type of forwarding element.

In an example, line cards within a network device 3 are communicatively coupled with other line cards within network device 3 and/or with line cards within other network devices. Line card 3E is connected to line card 3D via an internal link (e.g., Bus/Direct Memory Access). Furthermore, line card 3E is physically connected to line card 1A in network device 1 and line card 4H in network device 4 via cables and network device interfaces.

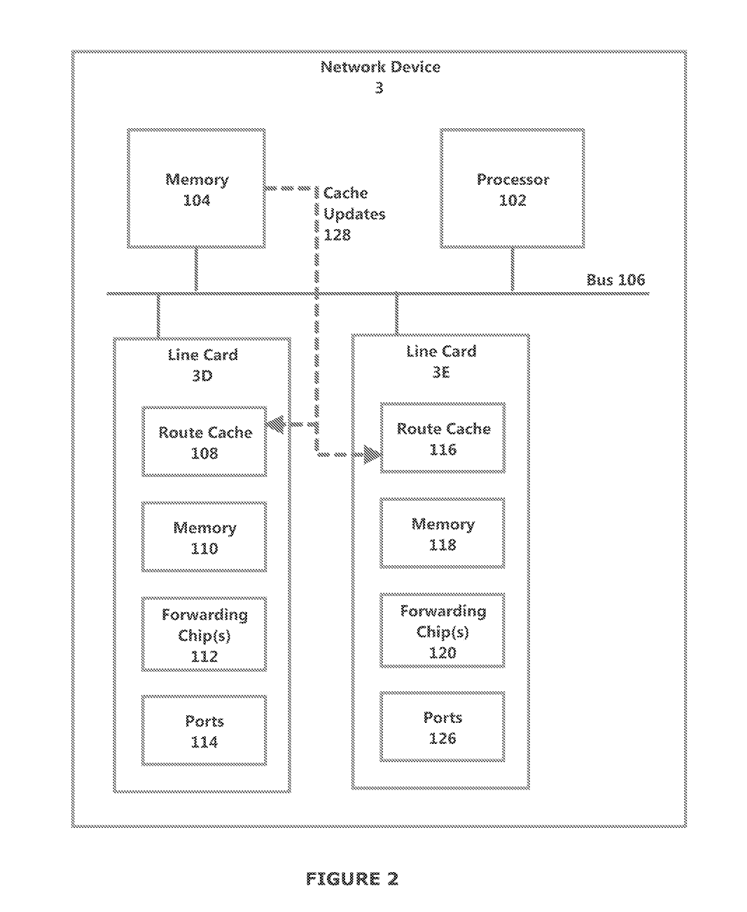

In an example, as illustrated in FIG. 2, network device 3 may include processor 102, memory 104, line card 3D, line card 3E, and bus 130. Bus 130 communicatively couples components (for example, processor 102, memory 104, line card 3D, line card 3E, etc.) within network device 1. Other components (not shown) within network device 3 may perform functionality described herein. More or less components may be implemented within network device 3. Accordingly, the specific components or functionalities described herein should not be construed as limiting the scope of any embodiments.

The memory 104 of the network device 3 comprises volatile and/or non-volatile memory. For instance, the memory 104 may include a fast read-write memory for storing programs and data during the network device 3's operations and a hierarchy of persistent memory such as ROM, EPROM, and Flash memory for storing instructions and data needed for the startup and/or operations of network device 3. The memory 104 stores data indicating route information for packets from network device 3 to other destination nodes. In an embodiment, the memory 104 is a distributed set of data storage components.

The processor 102 is communicatively coupled to the memory 104 via bus 106. The processor 102 may be any processing device including, but not limited to a MIPS-class processor, a microprocessor, a digital signal processor, an application specific integrated circuit, a microcontroller, a state machine, or any type of programmable logic array.

In an embodiment, a line card includes a route cache (e.g., route cache 108 and route cache 116), memory (e.g., memory 110 and memory 118), one or more forwarding chips (e.g., forwarding chip(s) 112 and forwarding chip(s) 126), and ports (e.g., ports 114 and ports 126). Ports 126 (e.g., 2 ports, 24 ports, 48 ports, or any other number of ports) in a line card are used for receiving packets from or transmitting packets to other network devices via cables. In an example, a first port of line card 3E is connected to a port of line card 1A via a twisted pair of cables for transmitting and/or receiving packets. Similarly, a second port of line card 3E is connected to a port of line card 4G.

In an embodiment, the route cache 116 caches information for routing packets. The route cache 116 indicates a next hop toward a destination address of a packet. The next hop may refer to a network device or a specific forwarding element within a network device. The route cache 116 may receive the information from a central master routing table maintained at another component of the network device (e.g., the memory 104) or at an external storage repository. In an example, the route cache 108 maintains information for recently used routes.

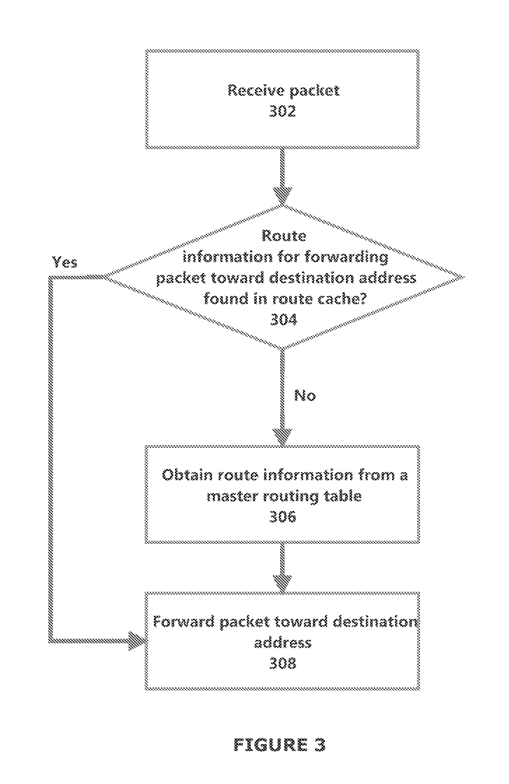

In an embodiment, the one or more forwarding chips (120) refer to network processors that quickly identify a next hop for routing packets based on a destination address for the packet. One example method for identifying a next hop is described below with reference to FIG. 3. The example method refers to a short route involving a few hops for purposes of explanation, however, the mechanisms described herein are equally applicable to longer routes where network device 5 is an intermediate node instead of a destination node. The method operations referred to in FIG. 3 may be omitted, rearranged, or otherwise modified, accordingly, the specific sequence of operations should not be construed as limiting the scope of any of the embodiments.

Initially a packet is received on one of the ports of line card 3E, where the packet is addressed to network device 5 (Operation 302). The packet may be addressed to an IP address of network device 5, to a MAC address associated with network device 5, or to a forwarding chip of network device 5. Forwarding chip (120) executes a query on route cache 116 to find route information in the route cache 116 for forwarding the packet to network device 5 (Operation 304). If the query fails to return any route information (i.e., a “cache miss”), route information is obtained from a master routing table maintained at memory 104 within network device 3 or from a different device (Operation 306).

In an embodiment, the route information identifies network device 4 as the next hop to reach network device 5. In one example, network device 4 may be identified indirectly by identification of the outbound port of line card 3E which is connected to line card 4H of network device 4. In another example, the network device 4 may be identified directly by IP address, MAC address, or other identification. In another example, the route information specifically identifies line card 4H of network device 4.

In an embodiment, the next hop is identified by processor 102 (and/or by another processor in a different network device) based on a selected route from network device 3 to network device 5. In an example, at least two routes from line card 3E to network device 5 are identified as follows:
a. Route 1: 3E->1A->10->2F->2G->5K
b. Route 2: 3E->4H->2G->5K

Accordingly, routes are identified based on internal component information such as line cards and/or internal links of network device 1, network device 2, and network device 4 in accordance with one or more embodiments. Alternatively or in addition, route information may indicate that data sent on a first port connected to line card 1A will reach the destination network device 5 in 5 hops (including internal hops between 1A & 1C, and between 2F & 2G). The route information may further indicate that data sent on a second port connected to line card 4H will reach the destination network device 5 in 3 hops.

In an embodiment, forwarding elements within network devices or network devices themselves may be referred to herein as “nodes” on a packet route. In an embodiment, route selection is based on identifying nodes that a packet traverses to reach a destination address and the cost of traversing links between the nodes.

In an embodiment, internal links (links between forwarding elements within a network device) and external links (links between different network devices) are each associated with a corresponding link cost. The link cost is generally proportional to the time it takes a packet to traverse the link. The cost varies based on distance between nodes, the medium travelled (e.g., internal bus, external cable, etc.), link traffic, etc. In an embodiment, a packet route (and thus the next hop) is selected based on the lowest total link cost across links (including external hops and internal hops) that are traversed to reach the destination node. Accordingly, in the example above, the route information may indicate that the total link costs for the (5) hops of route 1 and the (3) hops for route 2. One of the routes may be selected based on the total link cost. However, for ease of explanation, this example assumes that all links costs are similar so the route with the lowest number of hops (3 hops) is selected, i.e., route 2 is selected. Based on a selection of route 2, network device 4 or line card 4H is determined to be the next hop and the packet is forwarded via a link from line card 3E to 4H.

The use by network device 3 of internal component information of other network devices, advantageously allows for route selection based on both external links between network devices and internal links within network devices which must be traversed to reach a destination node. Without the internal component information, the routes from network device 3 to network device 5 (a) via network device 1 and (b) via network device 4 would erroneously appear to be equally efficient since each route has 3 hops (example assumes each hop between network devices has an equal cost for purposes of clarity and explanation).

One or more embodiments are directed to individually addressing forwarding elements within a different network device and identifying the forwarding elements as nodes on a route. Identification of internal forwarding elements for routing purposes is advantageous over identification only of network devices because identification of forwarding elements allows for consideration of internal links (and associated costs) between internal forwarding elements.

In an embodiment, network devices 1-5 may be switches within a same switch stack. A switch stack is a set of switches that are communicatively coupled and may be physically connected to at least one other switch in the same stack. A switch stack may include a set of switches at a same location (for example, in a same room or a same housing). Individual line cards within a switch may be individually addressed. In one example, line cards may be labeled using a variation of a MAC address of the switch. Line card 4H may be labeled for routing purposes with the MAC address of network device 4 appended with “H”.

In an embodiment, a controller (or other device) may maintain route information including link costs for internal links within a device. The controller may distribute the route information including link costs for internal links to nodes within a network. In an embodiment, the controller determines link costs for internal links by querying switches or other devices with internal components with their own respective set of ports. The controller may maintain data indicating which specific forwarding element of a first set of forwarding elements within a first switch is physically connected to which other specific forwarding element of a second set of forwarding elements within a second switch. The controller may determine paths between switches based, in part, on link costs for internal hops between forwarding elements within a switch. The controller may distribute path information and or raw data identifying connections.

As used herein, the term “interconnect” or used descriptively as “interconnected” is generally defined as a communication pathway established over an information-carrying medium. The “interconnect” may be a wired interconnect, wherein the medium is a physical medium (e.g., electrical wire, optical fiber, cable, bus traces, etc.), a wireless interconnect (e.g., air in combination with wireless signaling technology) or a combination of these technologies.

As used herein, “information” is generally defined as data, address, control, management (e.g., statistics) or any combination thereof. For transmission, information may be transmitted as a message, namely a collection of bits in a predetermined format. One type of message, namely a wireless message, includes a header and payload data having a predetermined number of bits of information. The wireless message may be placed in a format as one or more packets, frames or cells.

As used herein, “wireless local area network” (WLAN) generally refers to a communications network links two or more devices using some wireless distribution method (for example, spread-spectrum or orthogonal frequency-division multiplexing radio), and usually providing a connection through an access point to the Internet; and thus, providing users with the mobility to move around within a local coverage area and still stay connected to the network.

As used herein, the term “mechanism” generally refers to a component of a system or device to serve one or more functions, including but not limited to, software components, electronic components, electrical components, mechanical components, electro-mechanical components, etc.

As used herein, the term “embodiment” generally refers an embodiment that serves to illustrate by way of example but not limitation.

It will be appreciated to those skilled in the art that the preceding examples and embodiments are exemplary and not limiting to the scope of the present disclosure. It is intended that all permutations, enhancements, equivalents, and improvements thereto that are apparent to those skilled in the art upon a reading of the specification and a study of the drawings are included within the true spirit and scope of the present disclosure. It is therefore intended that the following appended claims include all such modifications, permutations and equivalents as fall within the true spirit and scope of the present disclosure.

While the present disclosure has been described in terms of various embodiments, the present disclosure should not be limited to only those embodiments described, but can be practiced with modification and alteration within the spirit and scope of the appended claims. The description is to be regarded as illustrative rather than limiting.

What is claimed is:

1. A method comprising:
identifying a particular link cost associated with an internal link between a first forwarding element and a second forwarding element that are inside a particular network device;
determining a total link cost for a first route from a first network device to a second network device via the particular network device, the total link cost comprising the particular link cost associated with the internal link between the first forwarding element and the second forwarding element that are inside the particular network device;
selecting one of the first route and a second route from the first network device to the second network device for forwarding a packet, based at least in part on the total link cost for the first route from the first network device to the second network device;
wherein the particular network device comprises a hardware processor.

2. The method of claim 1, wherein the first forwarding element and the second forwarding element are line cards inside the third network device.

3. The method of claim 1, further comprising labeling the first forwarding element based, at least in part, on a Media Access Control (MAC) address of the third network device.

4. The method of claim 1, wherein the second route does not include the particular network device and further comprising:
selecting the second route for forwarding the packet based, at least in part, on the internal link cost for the internal link between the first forwarding element and the second forwarding element that are inside the third network device.

5. The method of claim 1, wherein the link cost for the internal link between the first forwarding element and the second forwarding element is computed based on a bandwidth of a bus between the first forwarding element and the second forwarding element.

6. The method of claim 1, further comprising forwarding, by the first network device, the packet toward the second network device based on the selected route of the first route and the second route.

7. The method of claim 1, further comprising:
identifying a set of network devices connected to ports of the second forwarding element;
identifying the first route from the first network device to the second network device based, at least in part, on the set of network devices connected to ports of the second forwarding element.

8. A non-transitory computer readable storage medium comprising instructions which, when executed by one or more processors, causes performance of operations comprising:
identifying a particular link cost associated with an internal link between a first forwarding element and a second forwarding element that are inside a particular network device;
determining a total link cost for a first route from a first network device to a second network device via the particular network device, the total link cost comprising the particular link cost associated with the internal link between the forwarding elements within the particular network device;
selecting one of the first route and a second route from the first network device to the second network device for forwarding a packet, based at least in part on the total link cost for the first route from the first network device to the second network device.

9. The computer readable storage medium of claim 8, wherein the first forwarding element and the second forwarding element are line cards inside the third network device.

10. The computer readable storage medium of claim 8, wherein the operations further comprise labeling the first forwarding element based, in part, on a Media Access Control (MAC) address of the third network device.

11. The computer readable storage medium of claim 8, wherein the second route does not include the particular network device and wherein the operations further comprise:
selecting the second route for forwarding the packet based, at least in part, on the internal link cost for the internal link between the first forwarding element and the second forwarding element that are inside the third network device.

12. The computer readable storage medium of claim 8, wherein the link cost for the internal link between the first forwarding element and the second forwarding element is computed based on a bandwidth of a bus between the first forwarding element and the second forwarding element.

13. The computer readable storage medium of claim 8, wherein the operations further comprise forwarding, by the first network device, the packet toward the second network device based on the selected route of the first route and the second route.

14. The computer readable storage medium of claim 8, wherein the operations further comprise:
identifying a set of network devices connected to ports of the second forwarding element;
identifying the first route from the first network device to the second network device based, at least in part, on the set of network devices connected to ports of the second forwarding element.

15. A device comprising:
one or more hardware processors;
the device being configured for performing operations comprising:
identifying a particular link cost associated with an internal link between a first forwarding element and a second forwarding element that are inside a particular network device;
determining a total link cost for a first route from a first network device to a second network device via the particular network device, the total link cost comprising the particular link cost associated with the internal link between the forwarding elements within the particular network device;
selecting one of the first route and a second route from the first network device to the second network device for forwarding a packet, based at least in part on the total link cost for the first route from the first network device to the second network device.

16. The device of claim 15, wherein the first forwarding element and the second forwarding element are line cards inside the third network device.

17. The device of claim 15, wherein the operations further comprise labeling the first forwarding element based, in part, on a Media Access Control (MAC) address of the third network device.

18. The device of claim 15, wherein the second route does not include the particular network device and further comprising:
selecting the second route for forwarding the packet based, at least in part, on the internal link cost for the internal link between the first forwarding element and the second forwarding element that are inside the third network device

19. The device of claim 15, wherein the link cost for the internal link between the first forwarding element and the second forwarding element is computed based on a bandwidth of a bus between the first forwarding element and the second forwarding element.

20. The device of claim 15, wherein the operations further comprise forwarding, by the first network device, the packet toward the second network device based on the selected route of the first route and the second route.

21. The device of claim 15, wherein the operations further comprise:
identifying a set of network devices connected to ports of the second forwarding element;
identifying the first route from the first network device to the second network device based, at least in part, on the set of network devices connected to ports of the second forwarding element.
